(19) United States
(12) Patent Application Publication
(10) Pub. No.: US 2009/0218489 A1
(43) Pub. Date: Sep. 3, 2009

(54) SYSTEMS AND METHODS FOR MATERIAL TREATMENT AND CHARACTERIZATION EMPLOYING POSITRON ANNIHILATION

(76) Inventors: Douglas William Akers, (US); Mark William Drigert, (US); Lyle Gene Roybal, (US)

Correspondence Address: TraskBritt / Battelle Energy Alliance, LLC, PO Box 2550, Salt Lake City, UT, 84110, US

(21) Appl. No.: 12/039,588

(22) Filed: Feb. 28, 2008

(51) Int. Cl. G01N 23/00; G21G 5/00

(52) U.S. Cl. 250/307; 250/492.1; 250/306

(57) ABSTRACT

Methods of treating materials include providing positrons within the material and detecting radiation emitted upon annihilation of positron-electron pairs within the material while treating the material. Treating the material may include subjecting the material to one or more of a pressure change, a temperature change, and a change in atmosphere while detecting the radiation. Methods of characterizing materials include providing a material in a non-equilibrium state, detecting electromagnetic radiation emitted upon annihilation of positron-electron pairs within the material, and detecting a change in one or more physical or chemical characteristics of the material. Systems for treating materials include an enclosure, a positron-generating device for providing positrons within material to be treated within the enclosure, and a radiation detection device for detecting radiation emitted upon annihilation of positron-electron pairs.

### GOVERNMENT RIGHTS

The United States Government has certain rights in this invention pursuant to Contract No. DE-AC07-05ID14517 between the United States Department of Energy and Battelle Energy Alliance, LLC.

### TECHNICAL FIELD

Embodiments of the present invention relate to methods and systems for treating materials, characterizing materials, and for both treating and characterizing materials.

### BACKGROUND

Positrons are the charged particles that have a mass equal to the mass of an electron and a positive charge equal in magnitude to the negative charge of an electron, and are considered the anti-particle or anti-matter of electrons. When a positron and an electron collide, the particles can annihilate one other. In other words, their mass is combined and converted into energy in the form of gamma rays. In general, two gamma ray photons each having an energy of about 511 keV are emitted in generally opposite directions (in directions oriented about 180 degrees relative to one another) upon annihilation of a positron-electron pair, although the precise direction of emission and energy of the gamma ray photons may be affected by the kinetic energy of the electron and the positron at the time of annihilation.

A positron within a material will diffuse away from the location of injection or generation due to thermal energy until it encounters and is annihilated with an electron. During this diffusion process, the positrons are repelled by positively charged nuclei and thus accumulate at locations within the lattice structure where the concentration of nuclei is relatively low, such as at the location of dislocations, vacant lattice sites, vacancy clusters, vacancy-impurity complexes, grain boundaries, interfaces, and pores, and other defects in the material, all of which are collectively referred to hereinafter as “lattice anomalies”.

The gamma ray photons emitted upon annihilation of a positron-electron pair can be detected. Furthermore, the energy of the detected gamma ray photons can be determined. By detecting the emitted gamma rays and determining their energy, certain characteristics of the material may be determined. As a result, positrons have been injected into or generated within materials, and gamma rays emitted upon annihilation of positron-electron pairs within the materials have been detected and used to gather information relating to the presence of lattice anomalies within the crystal lattice of the materials. Such information can be used to characterize embrittlement, fatigue, and other material characteristics.

Positrons can be injected into a material to be tested by directing positrons generated outside the material from a positron source toward the material. Such positron sources include, for example, radioactive isotopes such as ²²Na, ⁶⁸Ge, and ⁵⁸Co which emit positrons during radioactive decay. Positrons injected into a material in this manner, however, generally migrate into the material to a limited depth, and material analysis techniques employing such positron injection methods are limited by the depth to which the positrons will migrate into the material. In other words, such injection techniques may be used to analyze material characteristics at or near the surface of the material.

To analyze material properties deeper within a material, radioactive isotopes may be generated or provided within the material itself, and the radioactive isotopes then generate positrons within the material as the radioactive isotopes decay. Positron-emitting radioactive isotopes may be generated or provided within a material by, for example, bombarding the material with neutrons (to add neutrons to atoms to form the positron-emitting radioactive isotopes) or photons (to remove neutrons from atoms to form the positron-emitting radioactive isotopes), which will penetrate into a material to a greater depth than will positrons. In such processes, however, the material must include atoms that will form positron emitting radioactive isotopes upon bombardment with neutrons or photons.

References that disclose systems and methods for characterizing materials that employ the detection of gamma rays emitted upon annihilation of positron-electron pairs include, for example, U.S. Pat. No. 6,178,218, issued Jan. 23, 2001 and entitled NONDESTRUCTIVE EXAMINATION USING NEUTRON ACTIVATED POSITRON ANNIHILATION, U.S. Pat. No. 7,231,011, issued Jun. 12, 2007 and entitled APPARATUS FOR PHOTON ACTIVATION POSITRON ANNIHILATION ANALYSIS, U.S. Patent Application Publication No. 2003/0161431, published Aug. 28, 2003 and entitled METHOD AND APPARATUS FOR EVALUATING MATERIALS USING PROMPT GAMMA RAY ANALYIS, and U.S. Patent Application Publication No. 2005/0117682, published Jun. 2, 2005 and entitled METHOD FOR ON-LINE EVALUATION OF MATERIALS USING PROMPT GAMMA RAY ANALYSIS, and U.S. Patent Application Publication No. 2006/0013350, published Jan. 19, 2006 and entitled METHOD AND APPARATUS FOR NON-DESTRUCTIVE TESTING, the entire disclosure of each of which document is incorporated herein by this reference.

Materials may be subjected to thermal treatment processes to change or tailor the microstructure of the material in such a way as to impart certain desirable physical or chemical characteristics to the material. Such thermal treatment processes include, for example, annealing processes, quenching processes, and phase precipitation processes. Thermal treatment processes may be carried out in a controlled environment, and certain process parameters including, for example, temperature, time at temperature, rate of temperature change, pressure, and chemical composition of the atmosphere may be controlled throughout the process.

The effects of varying process parameters in thermal treatment processes on the material being treated may be assessed by performing multiple thermal treatment processes and varying the parameters of the process in a predetermined, calculated, and controlled manner during those processes. The resulting microstructures of the materials treated in such thermal treatment processes then may be analyzed, and the microstructural characteristics of the materials may be correlated to the respective variations in the process parameters to determine how variations in each of the process parameters will affect the resulting microstructure. The results of such parametric studies often do not allow accurate prediction of the microstructural characteristics that will result in a particular material upon treating the material using any given set of process parameters.

### BRIEF SUMMARY OF THE INVENTION

In some embodiments, the present invention includes methods of treating materials that include providing positrons within a material and detecting electromagnetic radiation emitted upon annihilation of positron-electron pairs within the material as the material is treated. For example, the methods may be used to thermally treat a material, and may include changing a temperature of a material while detecting radiation emitted upon annihilation of positron-electron pairs.

In additional embodiments, the present invention includes methods of treating materials that include subjecting a material to a controlled environment, detecting radiation emitted upon annihilation of positron-electron pairs within the material, and adjusting at least one of a temperature, a pressure, and a chemical composition of an atmosphere within the environment in response to the detected radiation.

In additional embodiments, the present invention includes methods of characterizing a material that include detecting a change in one or more physical or chemical characteristics of a material in a non-equilibrium state using radiation emitted upon annihilation of positron-electron pairs within the material.

In yet other embodiments, the present invention includes material treatment systems that include an enclosure, a positron-generating device for providing positrons within material to be treated within the enclosure, and a radiation detection device configured to detect radiation emitted upon annihilation of positron-electron pairs within material to be treated within the enclosure.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a schematic diagram illustrating an embodiment of a material treatment system of the present invention that includes a device for generating positrons in a material to be treated and a radiation detection device for detecting radiation emitted upon annihilation of the positrons in the material;

FIG. 2 is a simplified figure illustrating a portion of an embodiment of a material treatment system as schematically illustrated in FIG. 1;

FIG. 3 is a diagram illustrating one example of a manner in which a shape of a curve may be characterized using a shape parameter;

FIG. 4 is a diagram illustrating different curves, each curve representing the intensity of radiation that may be detected by the radiation detection device illustrated in FIG. 1 as a function of the energy of the detected radiation; and

FIG. 5 is an example of a chart illustrating shape parameters measured over a two-dimensional area or region of a material being treated using the system of FIG. 1, each shape parameter having been obtained from an intensity versus energy curve obtained by detecting radiation emitted from a plurality of locations over the two-dimensional area or region of the material.

### DETAILED DESCRIPTION OF THE INVENTION

The illustrations presented herein are not meant to be actual views of any particular apparatus or system, but are merely idealized representations that are employed to describe various embodiments of the present invention. It is noted that elements that are common between figures may retain the same numerical designation.

As used herein, the term “thermal treatment process” means and includes any process in which matter is subjected to an environment in which at least the temperature of the environment is controlled either to form a particular material from the matter, or to alter one or more physical or chemical characteristics of a material (e.g., average grain size, phase composition, phase distribution, hardness, strength, modulus, etc.) comprising the matter. Other parameters also may be controlled in thermal treatment processes such as, for example, rate of temperature change, pressure, rate of pressure change, and atmosphere composition. Thermal treatment processes include, for example, sintering processes, annealing processes, quenching processes, and phase precipitation processes.

As used herein, the term “non-equilibrium state” means any state of a material in which one or more physical and/or chemical characteristics of the material are changing appreciably with time. Non-equilibrium states, as used herein, do not include metastable states, in which the free energy of the material system is not at a minimum, but the characteristics of the material system are not changing or are changing so slowly with time that the changes are not appreciable.

As used herein, the term “controlled environment” means any environment in which one or more of a temperature, a pressure, and a chemical composition of the atmosphere within the environment is controlled. By way of nonlimiting example, the environment within a temperature controlled furnace is a controlled environment.

According to embodiments of the present invention, electromagnetic radiation emitted from a material upon annihilation of positron-electron pairs within the material is detected while a thermal treatment process is being performed on the material. The emitted electromagnetic radiation may be used to identify one or more characteristics of the material in real time during the thermal treatment, and information obtained from such electromagnetic radiation may be used to adjust one or more parameters (e.g., temperature, rate of temperature change, pressure, rate of pressure change, or atmosphere composition) of the thermal treatment process to tailor one or more physical or chemical characteristics of the material being treated. In further embodiments of the invention, material treatment systems are configured to perform such methods.

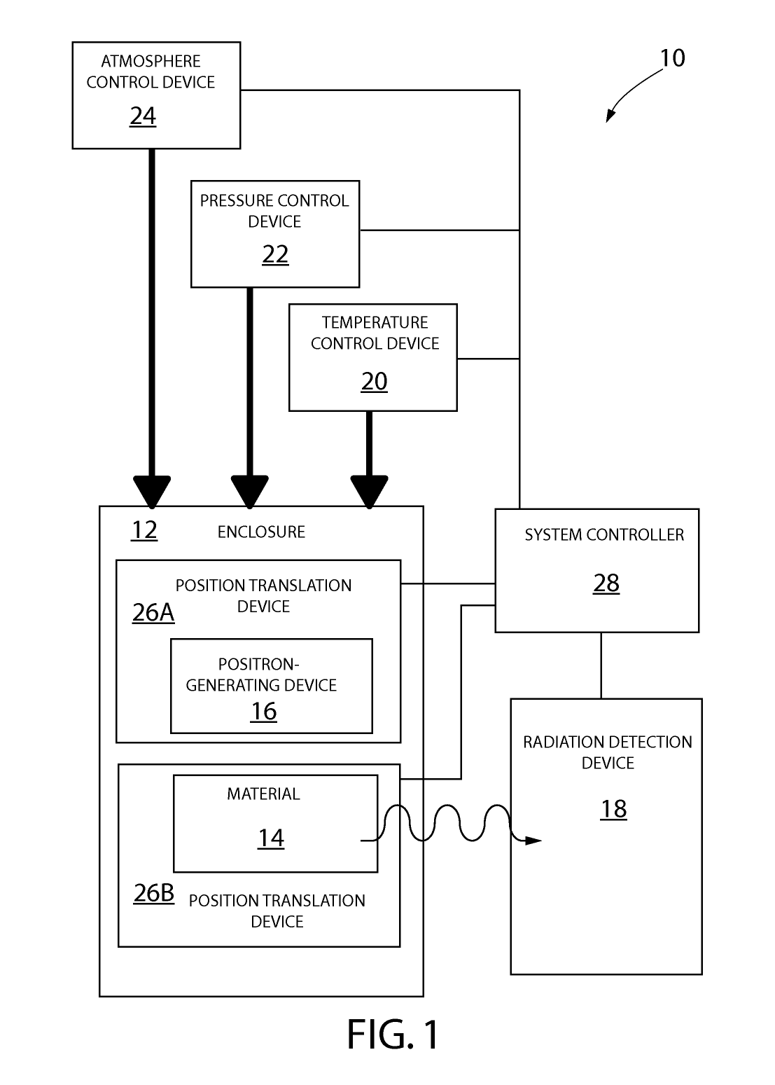

An embodiment of a material treatment system 10 of the present invention is schematically illustrated in FIG. 1. The material treatment system 10 includes an enclosure 12 within which material 14 may be treated by the material treatment system 10. The material treatment system 10 further includes a positron-generating device 16 configured to generate positrons within the material 14 to be treated by the material treatment system 10, and a radiation detection device 18 configured to detect radiation emitted upon annihilation of positron-electron pairs within the material 14 during treatment of the material by the system 10. As shown in FIG. 1, in some embodiments, the radiation detection device 18 may be located outside the enclosure 12. In other embodiments, the radiation detection device 18 may be located at least partially within the enclosure 12.

In some embodiments, the enclosure 12 may comprise a furnace for thermally treating material 14, and the material treatment system 10 may further comprise a temperature control device 20 for controlling the temperature within the furnace.

In addition or as an alternative, the material treatment system 10 may further include one or both of a pressure control device 22 for controlling the pressure within the enclosure 12, and an atmosphere control device for controlling the chemical composition of the atmosphere within the enclosure 12. A position translation device also may be used to provide relative movement between the positron-generating device 16 and the material 14 to be treated within the enclosure 12. For example, the positron-generating device 16 may be mounted on a position translation device 26A configured to move the positron-generating device 16 relative to the material 14, the material 14 may be disposed on a position translation device 26B configured to move the material 14 relative to the positron-generating device 16, or both.

The material treatment system 10 may further include a system controller 28 configured to selectively control one or more of the various controllable components of the system 10, such as, for example, the radiation detector 18, the temperature control device 20, the pressure control device 22, the atmosphere control device 24, and the one or more position translation devices 26A, 26B.

Each of the various components of the material treatment system 10 is described in further detail below.

With continued reference to FIG. 1, the enclosure 10 may comprise any suitable container for treating a material 14. The enclosure 10 may be hermetically sealed to facilitate control of the environment within the enclosure 10. As previously mentioned, the enclosure 10 may comprise a furnace for thermally treating materials 14 therein. By way of example and not limitation, the enclosure 10 may comprise a combustion furnace, an induction furnace, a vacuum furnace, an electrical resistance furnace, or a hot isostatic pressing (HIP) furnace, or a furnace including combinations of heat sources. Such furnaces may be used to perform thermal treatment processes for forming particular materials from matter and/or to altering one or more physical or chemical characteristics of materials (e.g., average grain size, phase composition, phase distribution, hardness, strength, modulus, etc.). Thermal treatment processes include, for example, sintering processes, annealing processes, quenching processes, and phase precipitation processes. Such processes may be used to tailor the composition and/or microstructure of a material 14 to cause the material 14 to exhibit desirable chemical and/or physical properties.

The temperature control device 20 may be used to control (e.g., selectively vary) the temperature within the enclosure 12, and hence, to control the temperature of the material 14. By way of example and not limitation, the temperature control device 20 may comprise a burner (not shown) for causing combustion of one or more fuels to generate heat within the enclosure 12, one or more temperature sensors (e.g., one or more thermocouples) (not shown) for sensing a temperature within the enclosure 12, and a controller (not shown), such as, for example, a programmable logic controller (PLC), for igniting the burner and/or controlling the rate of flow of fuel to the burner in response to signals received from the one or more temperature sensors. As another example, the enclosure 12 may comprise or be part of an induction furnace, and the temperature control device 20 may comprise one or more conductive coils (not shown) configured to surround the material 14, a power supply (not shown) configured to pass electrical current through the conductive coils to generate magnetic fields in a region comprising the material 14, one or more temperature sensors (e.g., one or more thermocouples) (not shown) for sensing a temperature within the enclosure 12, and a controller (not shown), such as, for example, a programmable logic controller (PLC), for controlling the flow of electrical current (e.g., the direction of current flow and the magnitude of the current flow) through the conductive coils in response to electrical signals received from the one or more temperature sensors.

In some embodiments, the temperature control device 20 also may comprise a cooling device configured to reduce the temperature within the enclosure 12 and, hence, the temperature of the material 14. For example, the temperature control device 20 may comprise a heat exchanger system for removing heat out from within the enclosure 20 and the material 14. In one non-limiting example embodiment, the temperature control device 20 may comprise a fluid pump configured to pump cooling fluid (e.g., liquid or gas) through associated plumbing within the enclosure 12, and a controller device may be used to control operation of the pump and the rate of flow of fluid through the associated plumbing. In such embodiments, the fluid pump also be used to provide heat within the enclosure (e.g., to function as a heat pump).

In the embodiments described above, the temperature control device 20 may be adapted to initiate and regulate heating and/or cooling of the material 14 within the enclosure 12 to one or more predetermined temperatures for predetermined amounts of time, and to further control the rate(s) of temperature change as the temperature of the material 14 is selectively varied using the temperature control device 20.

The positron-generating device 16 is configured to provide positrons within the material 14 while the material 14 is disposed within the enclosure 12 before, during, and/or after treatment of material 14 by the material treatment system 10. By way of example and not limitation, the positron-generating device 16 may comprise any of the positron-generating devices disclosed in U.S. Pat. No. 6,178,218 to Akers et al. In some embodiments, the positron-generating device 16 may comprise, for example, a positron-emitting material or device configured to emit positrons toward the material 14. As one non-limiting example, the positron-generating device 16 may comprise a quantity of one or more of ²²Na, ⁶⁸Ge, and ⁵⁸Co, and optionally, such materials may be encapsulated in a material such as titanium. Such positron sources are commercially available from, for example, Eckert & Ziegler Isotope Products of Valencia, Calif. Optionally, the positron-generating device 16 may be configured to emit a beam of positrons toward the material 14. In other embodiments, if one or more elements within the material 14 is capable of generating positrons upon input of energy to the material (e.g., through impingement by photons, neutrons, or other particles) the positron-generating device 16 may comprise a device configured to input energy into the material 14 (e.g., by emitting photons, neutrons, other particles, or another form of energy toward the material 14) to cause the material 14 itself to generate positrons therein.

As previously discussed herein, positrons provided within the material 14 by the positron-generating device 16 are repelled by positively charged nuclei and accumulate at lattice anomalies within the lattice structure or structures of the material 14, where the concentration of nuclei is relatively low. As the photons combine with electrons and are annihilated, the resulting gamma ray emissions may be detected using the radiation detection device 18.

The radiation detection device 18 may comprise, for example, a high purity germanium (HPGe) photon detector device, such as, for example, those commercially sold under the Trademark ORTEC by Advanced Measurement Technology, Inc. of Oakridge, Tenn.

As previously mentioned, the material treatment system 10 optionally may further include one or both of a pressure control device 22 and an atmosphere control device 24. In some embodiments, the pressure control device 22 and the atmosphere control device 24 may be separate devices or systems, as represented schematically in FIG. 1. In other embodiments, however, the pressure control device 22 and the atmosphere control device 24 may be part of a single device or system.

The pressure control device 22 may comprise, for example, one or more pumps (not shown) configured to pump gas or gasses into the enclosure 12 and/or to pump gas or gasses out from the enclosure 12. The pressure control device 22 may further include a pressure sensor (not shown) for sensing the pressure within the enclosure 12, and a control device (not shown) for controlling operation of the one or more pumps in response to electrical signals received from the pressure sensor to provide or maintain predetermined pressure(s) within the container 12 during treatment of the material 14.

The atmosphere control device 24 may comprise, for example, a source of reactive gasses (e.g., reducing or oxidizing gasses) and/or inert gases (e.g., argon gas) and plumbing configured to allow the reactive and/or inert gases to flow into, through, and out from the enclosure 12. Optionally, one or more pumps may be used to drive the flow of the reactive and/or inert gases through the enclosure 12, although, such pumps may not be needed if, for example, the reactive and/or inert gases are supplied by a pressurized gas source.

As previously mentioned, the material treatment system 10 may further comprise a position translation device configured to provide relative movement between the material 14 and the positron-generating device 16, such as the position translation device 26A and/or the position translation device 26B. As non-limiting examples, the position translation device 26A may comprise a robotic arm (not shown) configured to move the positron-generating device 16 in one, two, or three dimensions relative to the material 14. The positron translation device 26B may comprise a platform on which the material 14 is supported during treatment and an electromechanical device (not shown) configured to move the platform in one, two, or three dimensions relative to the positron-generating device 16.

The system controller 28 may comprise a computer device, such as, for example, a desktop computer, a laptop computer, a server, or a programmable logic controller. The system controller 28 may be used both for controlling the various controllable components of the system 10 (e.g., the radiation detector 18, the temperature control device 20, the pressure control device 22, the atmosphere control device 24, and the one or more position translation devices 26A, 26B) and for collecting and processing data received from the radiation detection device 18. Optionally, the system controller 28 may be configured to create one or more graphical representations of the data. Furthermore, the system controller 28 may be configured under control of a software program to automatically adjust one or more operating parameters of the material treatment system 10 in response to data obtained from the radiation detection device 18.

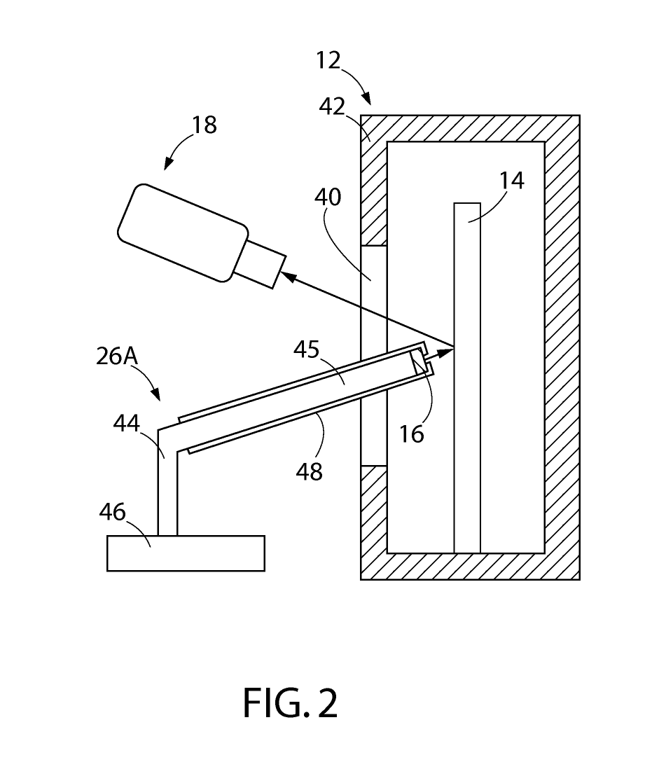

FIG. 2 is a simplified figure illustrating a portion of an example embodiment of a material treatment system 10 as schematically illustrated in FIG. 1. As shown in FIG. 2, in some embodiments, the enclosure 12 may comprise a furnace having an opening 40 in a wall 42 thereof. In such embodiments, a material 14 may be subjected to a thermal treatment process within the furnace. The positron-generating device 16 may comprise a quantity of one or more of ²²Na, ⁶⁸Ge, and ⁵⁸Co, and optionally, such materials may be encapsulated in a material such as titanium, and a hole or slit may be formed through the encapsulation material such that positrons are primarily emitted through the hole or slit. As shown in FIG. 2, the positron-generating device 16 may be mounted on the end of a probe 44, which may be structurally mounted on a position translation device 26A comprising a robotic arm 45. The robotic arm 45 may be mounted to a base 46, and the base 46 and robotic arm 45 may be located outside the enclosure 12. The probe 44 may extend from the robotic arm 45 into the enclosure 12 through the opening 40 in the wall 42 of the enclosure 12. The probe 44 may be configured to position the positron-generating device 16 within about twelve (12) inches or less from the material 14.

The robotic arm 45 may be used to selectively move the positron-generating device 16 relative to the material 14 within the enclosure 12 before, during, and/or after the material 14 is subjected to a thermal treatment process within the enclosure 12. In this manner, various regions or areas of the material 14 may be analyzed before, during, or after the material 14 is subjected to a thermal treatment process within the enclosure 12.

The probe 44 may be formed from a material that is capable of withstanding the temperatures within the furnace. For example, the probe 44 may be formed from high-temperature ceramic or metal materials. Furthermore, a cooling system may be used to cool the probe 44 and/or the positron-generating device 16 within the furnace. By way of example and not limitation, a cooled liquid or gas (e.g., nitrogen) may be caused to flow over at least a portion of the interior and/or exterior surfaces of the probe 44 and/or the positron-generating device 16 within the furnace. For example, such cooled liquid or gas may be caused to flow over the exterior surfaces of the probe 44 and/or the positron-generating device 16 within the furnace through a cooling jacket 48 provided thereover, as shown in FIG. 2. Furthermore, the cooling system may further include a sensor (e.g., a thermocouple) for monitoring a temperature of the positron-generating device 16 within the furnace.

With continued reference to FIG. 2, as positrons are provided within the material 14 by the positron-generating device 16, gamma radiation emitted upon annihilation of the positrons (with electrons) may be detected by a radiation detection device 18 located outside the enclosure 12. Although not shown in the figures, one or more positron shields may be used to prevent positrons interacting with the positron-generating device 16 or the surrounding enclosure 12 from reaching the radiation detection device 18.

The particular configuration shown in FIG. 2 of various components is illustrated as one non-limiting example of a particular embodiment of a material treatment system 10 (FIG. 1) of the present invention. Other configurations are also within the scope of the present invention. For example, in other embodiments, the probe 44 need not be mounted to a robotic arm, but may simply be mounted to a device that is configured to move the probe 44 relative to the material 14 in one, two, or three dimensions (e.g., an electromechanical XY stage configured to move the probe in two dimensions (the horizontal X and Y dimensions)).

Embodiments of material treatment systems of the present invention, such as the material treatment system previously described with reference to FIGS. 1 and 2, may be used to perform methods of the present invention for treating material 14, as described in further detail below.

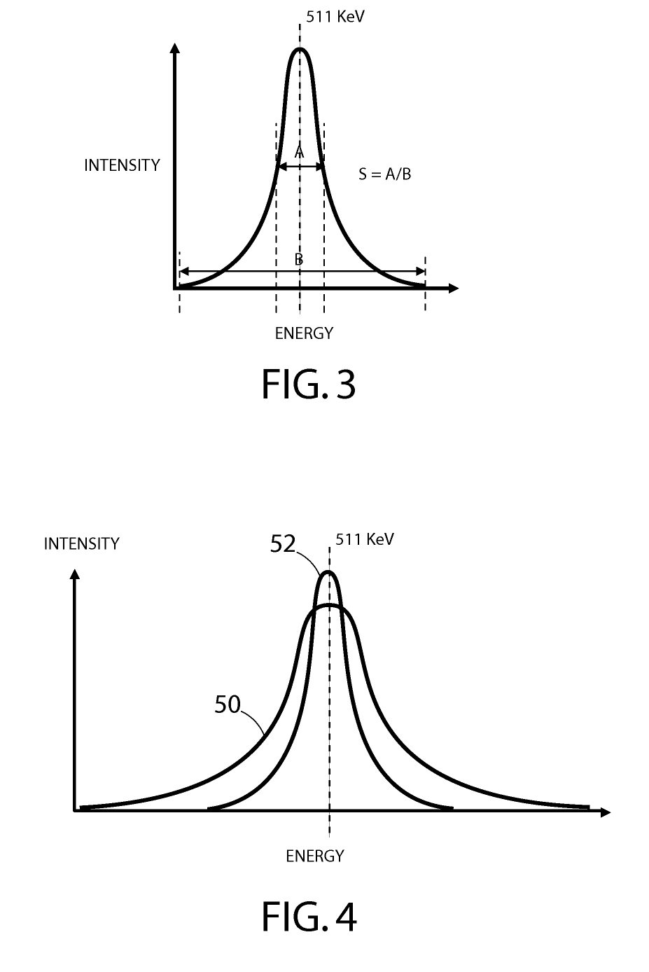

As positrons are provided within a material 14, positrons will combine and annihilate with electrons, which results in the emission of gamma rays. The radiation detector device 18 may be used to detect the intensity (as measured by counts) of the detected gamma rays as a function of their wavelength, or energy. As previously mentioned, two gamma ray photons each having an energy of about 511 keV are emitted in generally opposite directions (in directions oriented about 180 degrees relative to one another) upon annihilation of a positron-electron pair, although the precise direction of emission and energy of the gamma ray photons may be affected by the kinetic energy of the electron and the positron at the time of annihilation. Therefore, when the radiation detector device 18 is used to detect the intensity (or counts) of the gamma rays as a function of their energy or wavelength, the resulting graph may appear generally as a bell curve that is centered at or near 511 keV, like the bell curve shown in FIG. 3.

Referring to FIG. 4, positrons that, at the time of annihilation, are located within the bulk material 14 remote from any lattice anomalies tend to combine with high energy core electrons of the elements comprising the bulk material 14. Such core electrons have relatively more kinetic energy at the time of annihilation, and, hence, the gamma ray photons that result from annihilation of the core electrons with positrons have an energy other than 511 keV upon annihilation. As a result, areas or regions within a material 14 that include relatively fewer lattice anomalies tend to exhibit a relatively broader curve like the first curve 50 shown in FIG. 4. Conversely, positrons that, at the time of annihilation, are located at or near lattice anomalies within a material 14 tend to combine with relatively lower energy valence and free electrons. Such valence and free electrons have relatively less kinetic energy at the time of annihilation, and, hence, the gamma ray photons that result from annihilation of the valence and free electrons with positrons have an energy closer to 511 keV upon annihilation. As a result, areas or regions within a material 14 that include relatively more lattice anomalies tend to exhibit a relatively narrower curve like the second curve 52 shown in FIG. 4. Therefore, the shape of the curve obtained using the radiation detection device 18 during treatment of material 14 may be used to determine or estimate the number of lattice anomalies present within the material 14.

Furthermore, the kinetic energy of positron-electron pairs within a material 14 at the time of annihilation may be at least partially related to the energy band structure of the bulk material 14. As different materials have different energy band structures, different bulk materials 14 will exhibit intensity/energy curves, like the energy curves 50, 52 of FIG. 2, even when the materials are at least substantially free of lattice anomalies. Therefore, the shape of the curve obtained using the radiation detection device 18 during treatment of material 14 may be used to identify or characterize the nature of the material itself, in addition to determining or estimating the number of lattice anomalies present within a particular material 14. Moreover, materials 14 may exhibit different phases or crystal structures, and the energy band structure may differ between different phases. As a result, the shape of the curve obtained using the radiation detection device 18 during treatment of material 14 may be used to identify or characterize the nature of a particular phase or crystal structure within a particular material 14.

Referring again to FIG. 3, the shape of a curve (like the first curve 50 and the second curve 52 shown in FIG. 4) may be characterized using a shape parameter variable S, which may be referred to as the “S parameter” and defined as the ratio of the width of the curve at one-half the height of the peak of the curve to the width of the curve at the base of the curve. For example, referring to FIG. 3, the curve shown therein has an S parameter equal to the ratio of A to B (A/B), where A is the width of the curve at one-half the height of the peak of the curve and B is the width of the curve at the base of the curve. Thus, the S parameter, which is a function of the shape of the curve, may be used to characterize the material 14 from which the curve was obtained using the material treatment system 10 of FIG. 1 (e.g., the S parameter may be used to identify a composition of the material 14, to identify one or more particular phases present within the material 14, to identify an average grain size within the material, and/or to estimate or determine an amount of lattice anomalies within the material 14.

In additional embodiments, the data obtained from the radiation detection device 18 may be subjected to a Doppler broadening algorithm to facilitate analysis thereof, as disclosed in any one of previously referenced U.S. Pat. No. 6,178,218, issued Jan. 23, 2001 and entitled NONDESTRUCTIVE EXAMINATION USING NEUTRON ACTIVATED POSITRON ANNIHILATION, U.S. Pat. No. 7,231,011, issued Jun. 12, 2007 and entitled APPARATUS FOR PHOTON ACTIVATION POSITRON ANNIHILATION ANALYSIS, U.S. Patent Application Publication No. 2003/0161431, published Aug. 28, 2003 and entitled METHOD AND APPARATUS FOR EVALUATING MATERIALS USING PROMPT GAMMA RAY ANALYIS, and U.S. Patent Application Publication No. 2005/0117682, published Jun. 2, 2005 and entitled METHOD FOR ON-LINE EVALUATION OF MATERIALS USING PROMPT GAMMA RAY ANALYSIS.

Referring again to FIGS. 1 and 2, the positron-generating device 16 and the radiation detection device 18 may be capable of testing or analyzing a limited area or volume of a material 14 at a given time. However, by using one or more position translation devices 26A, 26B to move the material 14 relative to the positron-generating device 16 in either a continuous or step-wise manner, multiple tests or analysis may be performed on different areas or regions of the material 14 to be analyzed, and the data from the multiple tests or analysis may be accumulated and compiled to form an image or graph that represents the variations in the shape of the intensity/energy curves obtained over a relatively larger area of the material 14, or within a relatively larger volume of the material 14. As previously discussed with reference to FIGS. 3 and 4, the shape of the intensity/energy curves can be used to gather information relating to the nature of the material 14, the presence and nature of different phases within the material 14, an average grain size of the material 14, and/or the density of lattice anomalies within the material 14.

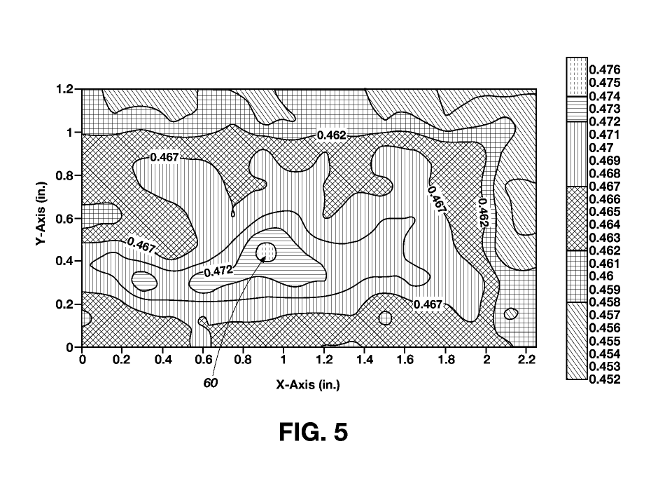

For example, each time a relatively small area or volume of material 14 is tested using the positron-generating device 16 and the radiation detection device 18, the data accumulated may be used to generate a curve (like the curves 50, 52 of FIG. 4) of the intensity of the detected gamma radiation as a function of energy (e.g., wavelength, frequency, or wave number), and the S parameter (or any other variable that is at least partially a function of the shape of the curve) may be calculated for that particular data set. After multiple, relatively smaller finite areas within a relatively larger area of a material 14 have been tested and an S parameter has been calculated for reach respective smaller area, an image or chart like that shown in FIG. 5 may be formed from the resulting data.

FIG. 5 is an image or chart representing a relatively larger area on a surface of a material 14 being treated using the material treatment system 10 (FIG. 1). The X and Y axis of the chart represent the X and Y directions in an XY plane on a surface of the material 14. The boundary and orientation of the XY plane may be determined prior to analyzing the material 14 using the positron-generating device 16 and the radiation detection device 18 (FIG. 1), as described above. As shown in FIG. 5, contour lines and/or different colors may be used to represent the S parameters measured within each of a plurality of relatively smaller finite areas (which are not delineated in FIG. 5) within the XY plane to form an image or chart like that of FIG. 5 that represents information relating to the nature of the material 14, the phase of the material 14, and average grain size of the material 14, and/or the density of lattice anomalies within the different areas or regions of the material 14 within the XY plane.

As shown in FIG. 5, the area or region 60 of the material exhibits a relatively narrow intensity/energy curve (and hence, relatively higher S parameters), while the surrounding areas or regions 60 of the material exhibit relatively broader intensity/energy curves (and hence, relatively lower S parameters).

Data regarding the shape of the intensity/energy curve for a particular material may be collected at least substantially continuously, or at predetermined intervals over a period of time, before, during, and/or after a material is treated using the material treatment system 10. For example, data regarding the shape of the intensity/energy curve for a particular material may be collected before, during, and/or after a material is subjected to a thermal treatment process using the material treatment system 10. For example, positrons may be provided within the material 14 using the positron-generating device 16. The temperature of the material 14 may be selectively changed or varied within the enclosure 12 to conduct a thermal treatment process. As the temperature is selectively changed or varied within the enclosure 12, electromagnetic radiation emitted upon annihilation of positron-electron pairs within the material 14 may be detected using the radiation detection device 18. As part of the thermal treatment process, at least one change in a physical or chemical characteristic of the material 14 may be induced by subjecting the material 14 to elevated or reduced temperatures within the enclosure 12, and the at least one change may be detected using the detected radiation emitted upon annihilation of positron-electron pairs within the material 14. Such changes in the material 14 may include phase changes, a change in a lattice structure of a material, a change in a density of defects within the material (e.g., dislocations and pores), a change in average grain size within the material, a change in a chemical composition of the material, etc.

Embodiments of the present invention are not limited to methods and systems for thermally treating materials. By subjecting a material 14 to, for example, elevated or reduced pressures or to atmospheres comprising one or more reagents (i.e., a reactive atmosphere) within the enclosure (in addition to, or as an alternative to subjecting the material 14 to elevated or reduced temperatures), the material 14 may be provided in a non-equilibrium state. As the material 14 transforms from a non-equilibrium state toward an equilibrium state, a change in one or more physical or chemical characteristics of the material 14 may be detected and identified by detecting and analyzing electromagnetic radiation emitted upon annihilation of positron-electron pairs within the material 14.

Embodiments of the invention may be used to determine what parameters and parameter changes of a thermal treatment process will result in the formation of a desirable microstructure in a material. Using embodiments of material treatment systems 10 as described herein, data may obtained from the detected gamma radiation emitted from the material 14 in situ during a material treatment process (e.g., a thermal treatment process), and the data may be represented visually as two dimensional curves (like those shown in FIGS. 3 and 4) or as three-dimensional charts or images (like that shown in FIG. 5) to allow the microstructure 14 to be monitored in real time during the material treatment process. By monitoring the material treatment process in real time, the process parameters of the material treatment process may be selectively varied in response to the data to selectively tailor the composition and/or microstructure of the material 14 resulting from the material treatment process.

In utilizing embodiments of material treatment systems of the present invention (like the material treatment system 10 of FIG. 1) to treat a particular material, it may be necessary or desirable to perform a calibration process for that particular material and system. For example, the material treatment system 10 could be used to perform an annealing process on a particular material to allow growth of grain crystals to a desirable average grain size. A number of substantially identical material samples may be prepared, and each may be subjected to the annealing process for different amounts of time. The average grain size of each sample may be determined using techniques known in the art. Positrons then may be provided within each sample using the positron-generating device 16, and the resulting gamma ray emissions may be detected using the radiation detection device 18. The data collected from each sample may be used to generate an S parameter, and a calibration curve then may be created correlating an average S parameter to an average grain size in the material 14. Thereafter, the material treatment system 10 may be used to perform the annealing process on that particular material 14, and the average S parameter of the material 14 may be monitored in situ during the annealing process. When the measured average S parameter of the material 14 corresponds to that of a desired average grain size, the annealing process may be terminated. Similar calibration techniques may be performed for other types of material treatment processes.

As embodiments of the present invention facilitate in situ monitoring of physical and or characteristics of materials 14 as they are treated, embodiments of the present invention may be used to adjust treatment parameters in real time during a material treatment process in response to data obtained from detected radiation emitted upon annihilation of positron-electron pairs within the material 14 in situ. For example, the material 14 may be subjected to a controlled environment within the enclosure 12, and at least one of a temperature, a pressure, and a chemical composition of the atmosphere within the enclosure 12 may be adjusted in response to information about the material 14 obtained by detecting the radiation emitted upon annihilation of positron-electron pairs within the material 14 as part of a material treatment process. More particularly, the system controller 28 may be configured under control of a software program to continuously receive the data obtained from the radiation detection device 18 during a material treatment process, to perform one or more algorithms on the data, and to adjust one or more operating parameters of one or more of the temperature control device 20, the pressure control device 22, and the atmosphere control device 24 to affect one or more changes in the material 14, which could be detected by the system controller 28 using the data obtained from the radiation detection device 18.

Embodiments of methods and systems of the present invention also may include performing a positron lifetime algorithm to produce positron lifetime data, as disclosed in any one of previously referenced U.S. Pat. No. 7,231,011, issued Jun. 12, 2007 and entitled APPARATUS FOR PHOTON ACTIVATION POSITRON ANNIHILATION ANALYSIS, U.S. Patent Application Publication No. 2003/0161431, published Aug. 28, 2003 and entitled METHOD AND APPARATUS FOR EVALUATING MATERIALS USING PROMPT GAMMA RAY ANALYIS, and U.S. Patent Application Publication No. 2005/0117682, published Jun. 2, 2005 and entitled METHOD FOR ON-LINE EVALUATION OF MATERIALS USING PROMPT GAMMA RAY ANALYSIS. As disclosed therein, such methods and systems may employ more than one radiation detection device 18.

Embodiments of methods and systems of the present invention may be used to treat many types of materials including metals, ceramics, polymers, and composite materials.

Furthermore, in some embodiments of the present invention, portable material treatment systems may be provided that include at least a positron-generating device 16, a radiation detection device 18, and a system controller 28. Such portable material treatment systems then may be used with existing enclosures (e.g., furnaces) to perform material treatment processes, as disclosed herein.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the scope of the invention as defined by the following appended claims and their legal equivalents.

What is claimed is:

1. A method of thermally treating a material, comprising:
controlling a temperature of a material;
providing positrons within the material; and
changing the temperature of the material while detecting electromagnetic radiation emitted upon annihilation of positron-electron pairs within the material.

2. The method of claim 1, wherein providing positrons within the material comprises one of injecting positions into the material and generating positrons within the material.

3. The method of claim 1, further comprising inducing at least one change in at least one characteristic of the material.

4. The method of claim 3, further comprising detecting the at least one change in the at least one characteristic of the material using the detected electromagnetic radiation.

5. The method of claim 4, wherein inducing at least one change in at least one characteristic of the material comprises at least one of
inducing a phase change in the material,
inducing a change in a lattice structure of the material, and
inducing a change in a density of defects within the material.

6. The method of claim 5, wherein inducing at least one change in at least one characteristic of the material comprises inducing a change in a density of at least one of dislocations and pores within the material.

7. A method of characterizing a material, comprising:
providing a material in a non-equilibrium state;
detecting electromagnetic radiation emitted upon annihilation of positron-electron pairs within the material; and
detecting a change in one or more physical or chemical characteristics of the material using the detected electromagnetic radiation.

8. The method of claim 7, wherein providing a material in a non-equilibrium state comprises at least one of heating the material and applying pressure to the material.

9. The method of claim 8, wherein providing a material in a non-equilibrium state comprises subjecting the material to a reactive atmosphere.

10. The method of claim 7, wherein detecting a change in one or more physical or chemical characteristics of the material comprises at least one of detecting a phase change in the material, detecting a change in a lattice structure of the material, and detecting a change in a density of defects within the material.

11. A method of treating a material, comprising:
subjecting a material to a controlled environment;
detecting electromagnetic radiation emitted upon annihilation of positron-electron pairs within the material; and
adjusting at least one of a temperature, a pressure, and a chemical composition of an atmosphere within the controlled environment in response to the detected electromagnetic radiation.

12. The method of claim 11, wherein subjecting the material to a controlled environment comprises:
disposing the material within a furnace; and
controlling a temperature within the furnace.

13. The method of claim 12, further comprising inducing at least one of a phase change within the material, a change in a lattice structure within the material, and a change in a density of defects within the material.

14. A material treatment system comprising:
an enclosure;
a temperature control device configured to control a temperature of material to be treated by the system within the enclosure;
a positron-generating device configured to provide positrons within material to be treated within the enclosure; and
a radiation detection device configured to detect electromagnetic radiation emitted upon annihilation of positron-electron pairs within material to be treated within the enclosure.

15. The system of claim 14, further comprising a pressure control device configured to control a pressure within the enclosure.

16. The system of claim 14, further comprising an atmosphere control device configured to control a chemical composition of an atmosphere within the enclosure.

17. The system of claim 14, wherein the enclosure comprises a furnace.

18. The system of claim 17, wherein the radiation detection device is disposed entirely outside the enclosure.

19. The system of claim 18, wherein at least a portion of the positron-generating device is disposed within the enclosure.

20. The system of claim 19, further comprising a cooling device configured to cool the at least a portion of the positron-generating device during treatment of material within the enclosure.

21. The system of claim 19, wherein the positron-generating device comprises a positron-emitting source configured to emit positrons toward material to be treated within the enclosure.

22. The system of claim 19, wherein the positron-generating device comprises a photon-emitting source configured to emit photons toward material to be treated within the enclosure.

23. The system of claim 14, further comprising a position translation device configured to provide relative movement between the positron-generating device and material to be treated within the enclosure.
